(19) United States
(12) Patent Application Publication
(10) Pub. No.: US 2012/0116930 A1
(43) Pub. Date: May 10, 2012

(54) METHOD AND SYSTEM FOR PROCESS-BASED ORIGIN MANAGEMENT

(75) Inventors: Moonyoung CHUNG, Daejeon (KR); Kyung-Ah YANG, Daejeon (KR); Kyong-I KU, Daejeon (KR)

(73) Assignee: Electronics and Telecommunications Research Institute, Daejeon (KR)

(21) Appl. No.: 13/289,692

(22) Filed: Nov. 4, 2011

(30) Foreign Application Priority Data
Nov. 4, 2010 (KR) 10-2010-0109352

(51) Int. Cl. G06Q 10/08

(52) U.S. Cl. 705/28

(57) ABSTRACT

A method for process-based origin management of a product includes inputting information regarding a product and an origin of a raw material of the product, extracting a list of determining processes matched to an agreement related to the product, determining an origin of the product by using the information of the product and the determining processes in the list, and outputting an origin determination result of the product.

### CROSS-REFERENCE(S) TO RELATED APPLICATION(S)

The present invention claims priority of Korean Patent Application No. 10-2010-0109352, filed on Nov. 4, 2010, which is incorporated herein by reference.

### FIELD OF THE INVENTION

The present invention relates to a technology for origin management of a product, and more particularly, to a method and system for process-based origin management in which an origin determination of a product under the FTA is modeled by business process so that the origin determination can be easily revised.

### BACKGROUND OF THE INVENTION

The free trade agreement (FTA) refers to an agreement for freely moving materials or services to enhance mutual trades between specific countries. The FTA also refers to a preferential trade agreement for lessening or removing trade barriers between countries or regional relations to realize freedom of trades therebetween.

A supplier, for example, exporting companies or a company delivering raw materials to the exporting companies should verify that an origin of a product is determined to be local to enjoy a duty benefit under the FTA. Therefore, each company should recognize a rule of origin for each trade agreement and product specific rules of origin to determine an origin of a product.

An existing technology for origin stores the rules of origin in a database, and programs determination logics. Thereafter, the technology determines an origin of a product whenever a request for determination of the origin is made.

Therefore, when a trade agreement is newly created or changed, the determination logic should be revised, which may be a very difficult and hard work to a manager, rather than a controller or programmer.

### SUMMARY OF THE INVENTION

In view of the above, the present invention provides a system and method for process-based origin management, in which an origin determination of a product under the FTA system is modeled by business process so that the origin determination can be easily revised when there is a new trade agreement or there is a change in contents of the trade agreements.

In accordance with a first aspect of the present invention, there is provided a method for process-based origin management of a product, the method including:

inputting information regarding a product and an origin of a raw material of the product;

extracting a list of determining processes matched to an agreement related to the product;

determining an origin of the product by using the information of the product and the determining processes in the list; and

outputting an origin determination result of the product.

Preferably, wherein said extracting a list of determining processes includes:

determining whether the product is for a domestic market or for export;

if the product is for a domestic market, extracting a list of determining processes of all agreements related to the product; and

if the product is for export, extracting a list of determining processes of an agreement related to a country to which the product is exported.

Preferably, said determining an origin of the product includes:

inquiring product specific rules stored in a database; and

determining the origin of the product by applying the product specific rules to the product.

Preferably, the agreement is selectively matched to at least one determining process.

Preferably, the determining process is based on a business process management system (BPMS).

Preferably, wherein the determining process is added or revised by the determination result.

In accordance with another aspect of the present invention, there is provided a system for process-based origin management of a product, the system including:

a data management module configured to provide an interface for inputting information regarding the product and an origin of a raw material of the product for origin determination of the product;

a database management module configured to store and manage the information of the product, product specific rules, and origin determination results;

an origin determination module configured to determine an origin of the product by using the information regarding a determining process and the product specific rules; and

an output unit for outputting the origin determination result for the product.

Preferably, the data management module includes:

a first input interface configured to input the information of the product; and

an second input interface configured to input the product specific rules.

Preferably, the data managing module further includes:

an adjustable value processor configured to create an adjustable value for origin determination based on the information of the product and the product specific rules.

Preferably, the database management module includes:

a product information database configured to store the information of the product;

an origin rule database configured to store a rule of origin; and

a product specific rule database configured to store the product specific rules.

Preferably, the determining process is matched to an agreement related to the product.

Preferably, the agreement is selectively matched to at least one determining process.

Preferably, the origin determination module includes:

an information manager configured to manage a determining process for the origin determination and the product specific rule;

a determining processor configured to determine the origin of the product based on the determining process and the product specific rule; and

an information extractor configured to extract the determining process and the product specific rule from the database management module and provide the extracted determining process and product specific rule to the determining processor.

Preferably, the determining process is based on a business process management system (BPMS).

Preferably, the determining process is added or revised by the determining processor.

Preferably, the determining processor manages a determination history of the determining process.

### BRIEF DESCRIPTION OF THE DRAWINGS

The above and other objects and features of the present invention will become apparent from the following description of embodiments, given in conjunction with the accompanying drawings, in which:

FIG. 1 shows a block diagram of a process-based origin management system in accordance with an embodiment of the present invention;

FIG. 2 illustrates a detailed block diagram of the data management module shown in FIG. 1;

FIG. 3 presents a detailed block diagram of the process-based origin determination module shown in FIG. 1;

FIG. 4 provides a detailed block diagram of the storage unit shown in FIG. 1;

FIG. 5 illustrates a process-based origin managing process which is performed in the origin determination module.

FIG. 6 depicts a detailed flowchart of the origin determining process of FIG. 5;

FIG. 7 exemplarily illustrates a case in which business processes for origin determination are matched to respective agreements;

FIG. 8 shows a screen illustrating a mapping state of business processed in the process-based origin management system in accordance with the embodiment of the present invention; and

FIG. 9 shows a screen illustrating a case in which processes are mapped to agreements in the process-based origin management system in accordance with the embodiment of the present invention.

### DETAILED DESCRIPTION OF THE EMBODIMENTS

Hereinafter, an embodiment of the present invention will be described in detail with the accompanying drawings.

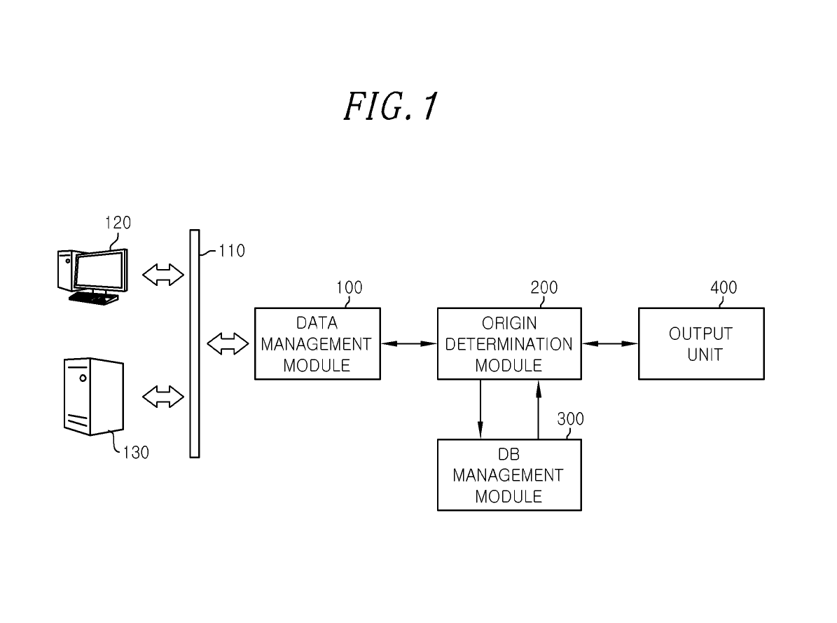

FIG. 1 shows a block diagram of a system for process-based origin management in accordance with an embodiment of the present invention. The system includes a data management module 100, an origin determination module 200, a database (DB) management module 300, and an output unit 400.

The system is connected to a terminal 120, for example, a PC in a company or an enterprise resource planning (ERP) system 130, through a wired/wireless network 110. A manager at the company makes a request for origin determination of a product and also inputs detailed information of the product through the terminal 120.

The data management module 100 manages the detailed information of the product input from the terminal 120.

Further, the data management module 100 provides the request for origin determination of the product to the origin determination module 200.

The origin determination module 200 determines an origin of a product by using the detailed information of the product, a business process (BP) based on a business process management system (BPMS), and product specific rules. Further, the origin determination module 200 controls the DB management module 300 to store the detailed information of the product, the product specific rules, and the origin determination result thereby.

The DB management module 300 stores the information of the product and the product specific rules, and the origin determination result. The information stored in the DB management module 300 may be selectively used by the origin determination module 200 as necessary.

The output unit 400 outputs the origin determination result, for example, the output unit 400 may issue a certificate of origin for the origin determination result in the form of a document or an image.

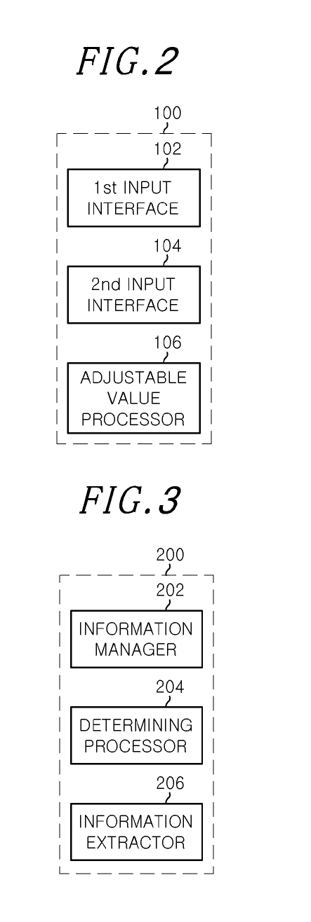

FIG. 2 illustrates a detailed block diagram of the data management module 100 shown in FIG. 1.

The data management module 100 includes a first input interface 102, a second input interface 104, and an adjustable value processor 106. The first input interface 102 is used for a company or a user (for example, a manager) of the company to input the detailed information of the product, and the second input interface 104 is used to input product specific rules prescribing rules of origin of products in advance.

The adjustable value processor 106 serves to create an adjustable value necessary for the origin determination depending on the detailed information of the product and the product specific rules provided through the first input interface 102 and the second input interface 140. A request for origin determination is made to the origin determination module 200 after obtaining the adjustable value.

FIG. 3 illustrates a detailed block diagram of the origin determination module 200 shown in FIG. 1. The origin determination module 200includes a information manager 202, a determination processor 204, and an information extractor 206.

The information manager 202 manages information about the BPs and the product specific rules that are stored in the DB management module 300. The information extractor 206 extracts information regarding a BP for origin determination and a product specific rule from the DB management module 300 and provides them to the determination processor 204. The determination processor 204 determines an origin of a product based on the BP, the product specific rule, and the detailed information of the product.

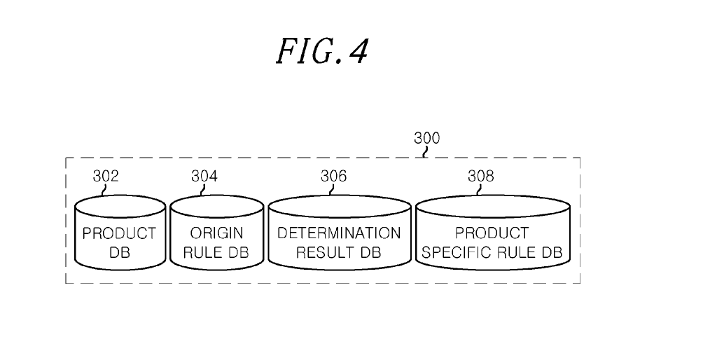

FIG. 4 illustrates a detailed block diagram of the DB management module 300 depicted in FIG. 1. The DB management module 300 includes a product information DB 302, an origin rule DB 304, a determination result DB 306, and a product specific rule DB 308.

The product information DB 302 stores the detailed information of products that are input through the data management module 100. The origin rule DB 304 stores rules of origin, i.e., product specific rules. The determination result DB 306 stores the origin determination results that have been obtained by origin determination module 200. The product specific rule DB 308 stores specific rules for products.

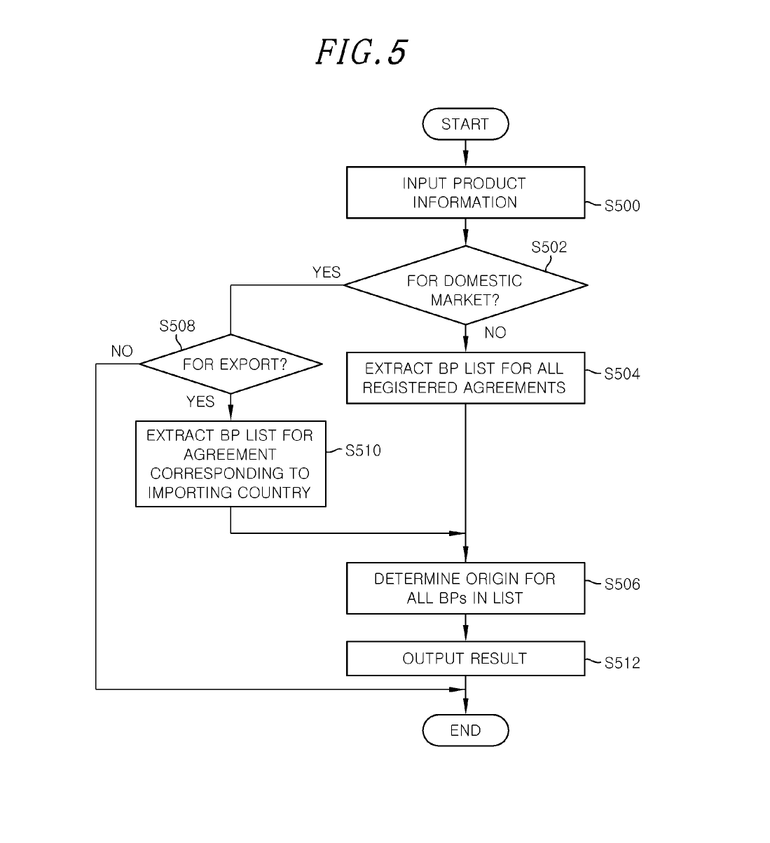

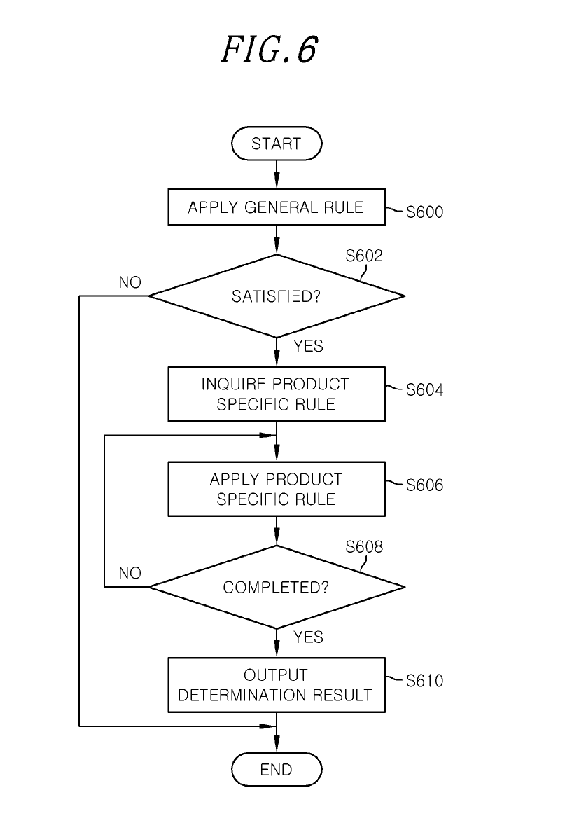

Hereinafter, a method for process-based origin management in accordance with an embodiment of the present invention will be described in more detail with reference to FIGS. 5 and 6.

FIG. 5 illustrates a process-based origin managing process which is performed in the origin determination module 200.

First, in step S500, the detailed information of a product whose origin is to be determined and description information regarding an origin of a raw material of the product are input through the data management module 100.

In step S502, the origin determination module 200 determines whether the product is for a domestic market. If the product is determined to be for a domestic market, the process proceeds to step S504; however, the process proceeds to step S508.

In step S504, the origin determination module 200 extracts a list of BPs associated with all registered agreements. After that, in step S506, the origin determination module 200 determines an origin of the product for the list of the BPs. Meanwhile, in step S508, it is determined that the product is for export. If the product is determined to be for export, the process proceeds to step S510; however, if not, the process ends for another origin determination of a product.

In step S510, the origin determination module 200 extracts a BP list associated with the agreement with the importing country of the product. Thereafter, in step S506, the origin determination module 200 determines an origin of the product based on the extracted BP list of the agreement(s).

If the origin of the product is determined on a basis of the BP list, the origin determination module 200 may output an origin determination result, e.g., a certificate of origin through the output unit 400 in step S512.

In accordance with the present invention, it is characterized in that the origin determining process is not programmed and stored in a program in a storage medium, but stored in the DB management module 300 after performing the origin determination through the use of BPs based on a BPMS. Thus, even when an agreement is newly added or revised, the origin management may be accomplished by adding or revising only a process, without revising a program. FIG. 6 illustrates details of the step S506 of origin determination shown in FIG. 5.

For the origin determination of a product, in step S600, a general rule for each agreement is first applied to a product.

Subsequently, in step S602, it is determined whether the product satisfies the requirement on the origin given in the general rule. If the product satisfies the origin requirement, in step S610, an origin determination result is output and the process ends. However, if the product fails to satisfy the origin requirement, the process proceeds to step S604.

In step S604, the origin determination module 200 inquires a product specific rule from the origin rule DB 304 of the DB management module 300, and applies the inquired product specific rule to the origin determination of the product in step S606.

Since there may exist at least one product specific rule stored in the origin rule DB 304, the origin determination module 200 repeatedly performs the above steps until all product specific rules are applied to the product in step S608.

If all the product specific rules are applied to the origin determination of the product, the process proceeds to step S610 in which the origin determining unit apparatus 200 outputs the origin determination result through the output unit 400 if necessary.

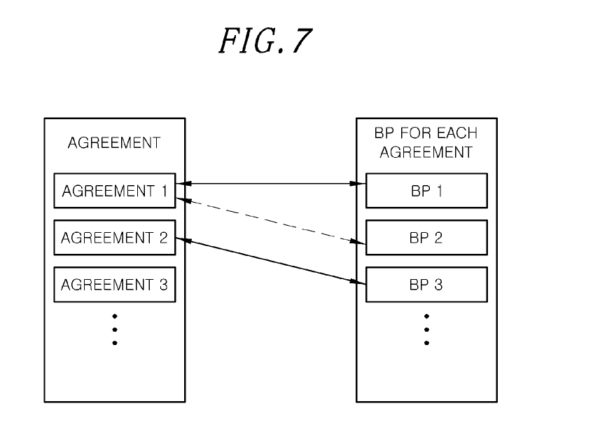

FIG. 7 illustrates a method of matching an origin determining process to each agreement in accordance with the embodiment of the present invention.

In accordance with the present invention, the process-based origin determination system may create multiple determining processes for each agreement, and may match a determining process to each agreement, wherein each determining process is created as a BP.

In other words, as illustrated in FIG. 7, multiple origin determining processes may be prescribed for each agreement, and one of the determining processes prescribed for one agreement may be matched to the agreement in order to actually make a determination. This mapping method can provide a user with the flexibility of the process-based origin determination system in use.

For example, as illustrated in FIG. 7, it is assumed that there exist two determining processes BP1 and BP2 in agreement 1. First, a determining process BP1 is mapped to the agreement 1 to perform an origin determination. If the agreement 1 is changed, the determining process BP1 is not revised but the determining process BP2 is created such that not BP1 but BP2 can be mapped to the determining process with the agreement 1.

Accordingly, in the embodiment of the present invention, it is possible to preserve a history about which determining process is used in obtaining the previous determination result using BP1.

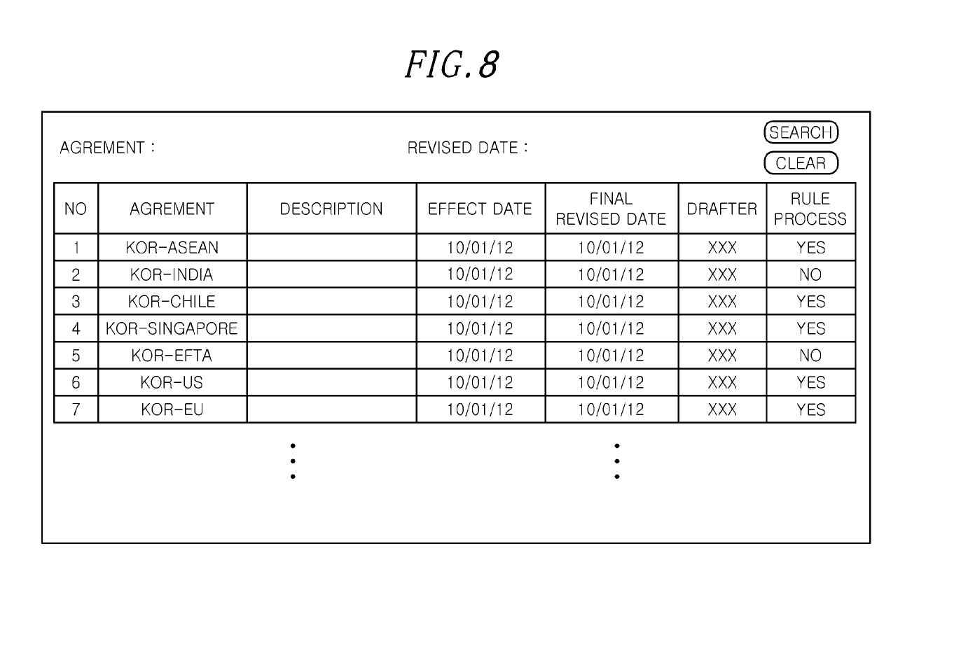

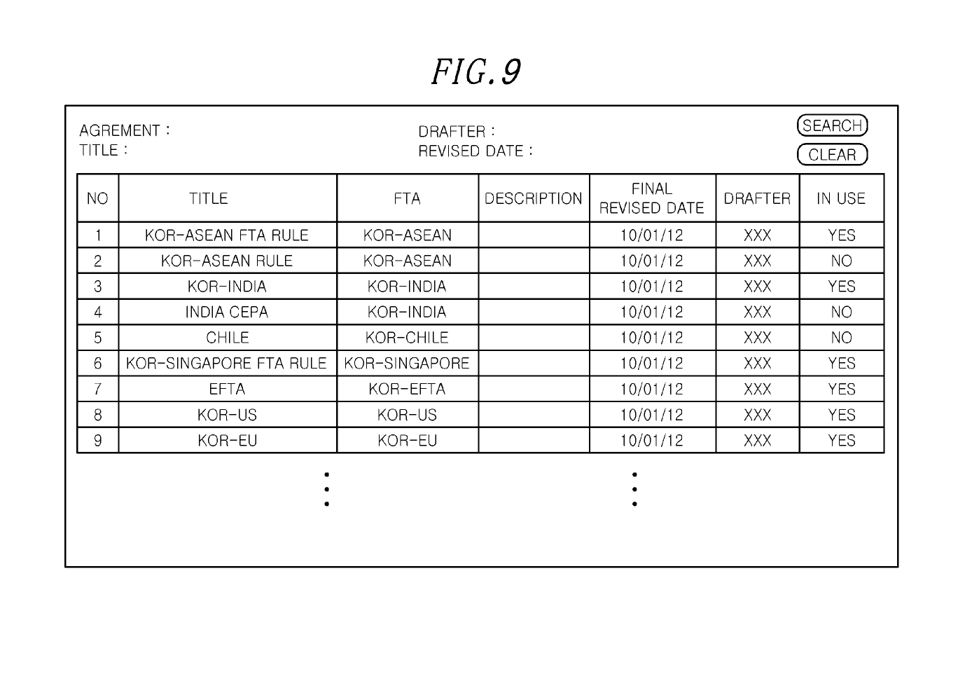

FIGS. 8 and 9 illustrate screens about the mapping of processes for each agreement provided in FIG. 7.

FIG. 8 illustrates an exemplary screen for agreement management in which processes are mapped, and FIG. 9 illustrates an exemplary screen of managing processes in which processes are matched to agreements.

As described above, in accordance with the embodiment of the present invention, the origin determination of a product under the FTA is modeled by business process so that the business process can be revised or added rather revising a determination program when the agreement is newly added or revised. Accordingly, a manager can easily revise or add an origin determining process, thus increasing convenience for management and business efficiency.

While the invention has been shown and described with respect to the particular embodiments, it will be understood by those skilled in the art that various changes and modification may be made without departing the scope of the present invention as defined in the following claims.

What is claimed is:

1. A method for process-based origin management of a product, the method comprising:
inputting information regarding a product and an origin of a raw material of the product;
extracting a list of determining processes matched to an agreement related to the product;
determining an origin of the product by using the information of the product and the determining processes in the list; and
outputting an origin determination result of the product.

2. The method of claim 1, wherein said extracting a list of determining processes includes:
determining whether the product is for a domestic market or for export;
if the product is for a domestic market, extracting a list of determining processes of all agreements related to the product; and
if the product is for export, extracting a list of determining processes of an agreement related to a country to which the product is exported.

3. The method of claim 1, wherein said determining an origin of the product includes:
inquiring product specific rules stored in a database; and
determining the origin of the product by applying the product specific rules to the product.

4. The method of claim 1, wherein the agreement is selectively matched to at least one determining process.

5. The method of claim 1, wherein the determining process is based on a business process management system (BPMS).

6. The method of claim 1, wherein the determining process is added or revised by the determination result.

7. A system for process-based origin management of a product, the system comprising:
a data management module configured to provide an interface for inputting information regarding the product and an origin of a raw material of the product for origin determination of the product;
a database management module configured to store and manage the information of the product, product specific rules, and origin determination results;
an origin determination module configured to determine an origin of the product by using the information regarding a determining process and the product specific rules; and
an output unit for outputting the origin determination result for the product.

8. The system of claim 7, wherein the data management module includes:
a first input interface configured to input the information of the product; and
a second input interface configured to input the product specific rules.

9. The system of claim 8, wherein the data managing module further includes:
an adjustable value processor configured to create an adjustable value for origin determination based on the information of the product and the product specific rules.

10. The system of claim 7, wherein the database management module includes:
a product information database configured to store the information of the product;
an origin rule database configured to store rules of origin; and a product specific rule database configured to store the product specific rules.

11. The system of claim 7, wherein the determining process is matched to an agreement related to the product.

12. The system of claim 11, wherein the agreement is selectively matched to at least one determining process.

13. The system of claim 11, wherein the origin determination module includes:
an information manager configured to manage a determining process for the origin determination and the product specific rule;
a determining processor configured to determine the origin of the product based on the determining process and the product specific rule; and
an information extractor configured to extract the determining process and the product specific rule from the database management module and provide the extracted determining process and product specific rule to the determining processor.

14. The system of claim 11, wherein the agreement includes a free trade agreement (FTA).

15. The system of claim 11, wherein the determining process is based on a business process management system (BPMS).

16. The apparatus of claim 11, wherein the determining process is added or revised by the determining processor.

17. The system of claim 11, wherein the determining processor manages a determination history of the determining process.
